(19) United States
(12) Patent Application Publication
(10) Pub. No.: US 2024/0089392 A1
(43) Pub. Date: Mar. 14, 2024

(54) SYSTEM AND METHOD FOR AUTHENTICATING DIRECT NETWORK PRINT JOBS

(71) Applicant: Toshiba TEC Kabushiki Kaisha, Shinagawa (JP)

(72) Inventors: William Su, Riverside, CA (US); Christopher Nguyen, Huntington Beach, CA (US)

(21) Appl. No.: 17/940,718

(22) Filed: Sep. 8, 2022

(51) Int. Cl. H04N 1/32; G06F 3/12; H04N 1/00; H04N 1/44

(52) U.S. Cl. CPC H04N 1/32523; G06F 3/1204; G06F 3/1231; G06F 3/126; H04N 1/00244; H04N 1/4433; G06F 3/1288

(57) ABSTRACT

A system and method for authenticating direct network print jobs includes registering users for direct printing with a cloud print server. Registration information is stored as a mapping record includes a user name, their computer name and an email address associated with their cloud storage account. When a user sends a print job directly to an MFP at its network address, the MFP checks with the cloud server to determine if the user is registered in accordance with their associated mapping record. If so, a permissions list for that user is checked to determine whether the user has print permission. The user's direct print is then released and their document is printed.

### TECHNICAL FIELD OF THE INVENTION

This application relates generally to printing. The application relates more particularly to authenticating multifunction peripheral users who bypass managed print services, sending their job directly to a multifunction peripheral via its network address.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

### BRIEF DESCRIPTION OF THE DRAWINGS

Various embodiments will become better understood with regard to the following description, appended claims and accompanying drawings wherein:

FIG. 1 is an example embodiment of a system for authenticating direct network print jobs;

FIG. 2 is an example embodiment of a networked digital device, such as multifunction peripheral;

FIG. 3 is an example embodiment of a digital device system;

FIG. 4 is a software module diagram of an example embodiment of a system for authenticating direct network print jobs;

FIG. 5 is a flowchart of an example embodiment of user registration in a system for authenticating direct network print jobs; and

FIG. 6 is a flowchart of an example embodiment of direct printing in a system for authenticating direct network print jobs.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

Early on, most printers were directly connected to a computer from which printing will be requested. More powerful devices, such as MFPs, would be prohibitively expensive for a single user. A common practice is to share an MFP among many networked users. Larger printing environments, such as businesses, law firms and schools, employ multiple MFPs which may be on multiple floors or at multiple locations. A particular networked printing environment may employ a print server. Users who are authenticated to this print server, which may be part of a cloud print service, can send their job directly to the print server and release it from any authenticated MFP. Direct network printing, such as sending a print job directly to an MFP's address such as their IP address, is a common alternative to print servers. In this method, users send print jobs from their own devices directly to a printer via their network. This system is convenient for a smaller user base or a decentralized setting where a resource-heavy print server would be overkill. A tradeoff is that there is less oversight and management capabilities in traditional direct IP printing. Without centralized user management and device permission, direct IP print jobs will be released on their own printing rules.

Cloud print services, such as the e-BRIDGE Global Print from Toshiba TEC, provide an application suite giving a platform for users to print to the cloud and release their jobs from any MFP that is registered with the cloud and is associated with the user. While any suitable print server service can be used, example embodiments herein reflect a use case of e-Bridge Global Print. With such a system, users can also send print jobs from their own devices straight to a printer. While it is understood that any MFP addressing may be used, such as a device network name, MAC address, etc., example embodiments herein reflect a use case of direct IP printing. Direct IP printing comes with its own limitations. Because direct printing is less centralized, it's time-consuming to configure printer drivers on every workstation.

Example embodiments herein provide an MFP application, referred to as an eApp that validates incoming direct IP print jobs against a centralized system before allowing them to print. Users need to first register for e-BRIDGE Global Print. The registration process sends a request to e-BRIDGE Global Print with the computer name and operating system (OS) username. A successful registration writes a user, such as Microsoft OneDrive or Google Drive user, computer name, and OS username in a table. This forms a mapping record.

When a registered user sends a print job from their own devices straight to an MFP, the MFP requests authentication to the MFP eApp. The MFP receives, via the eApp, the username and computer name of the job owner, and then the eApp requests authentication to e-BRIDGE Global Print. If e-BRIDGE Global Print responds with an OK, the MFP receives a device permission list and releases the print job.

The example embodiment summarized above provides several features. A centralized user management automatically syncs with the devices of all users in the organization. Users cannot be impersonated since a username and computer name are provided in the direct IP printing. Centralized device permission management allows a centralized system to control operation and render visibility of each MFP in the organization.

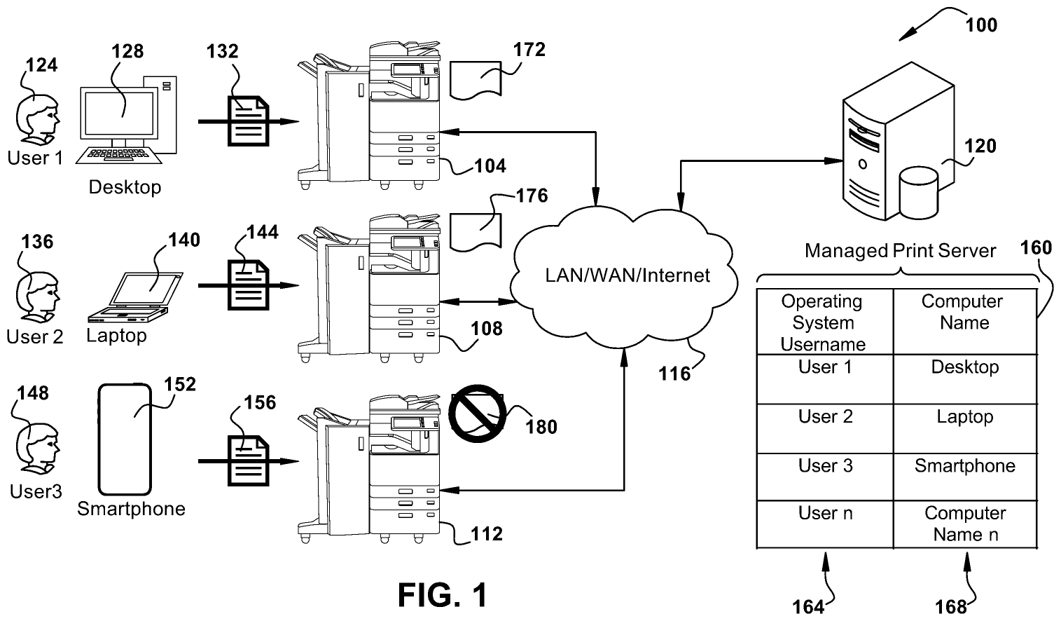

FIG. 1 illustrates an example embodiment of a system 100 for authenticating direct network print jobs. One or more MFPs, such as MFPs 104, 108 and 112, are in data communication with network cloud 116. Network cloud 116 is suitably comprised of a local area network (LAN), a wide area network (WAN), which may comprise the Internet, or any suitable combination thereof. Network cloud 116 is suitably comprised of any wired or wireless data communication medium. Also in data communication with network cloud 116 is managed print server 120. In the illustrated example, user 124 uses desktop computer 128 as their device to send print job 132 directly to MFP 104 via network cloud 116. User 136 uses laptop computer 140 as their device to send print job 144 directly to MFP 108 via network cloud 116. User 148 uses smartphone 152 as their device to send print job 156 directly to MFP 112 via network cloud 116. All users are registered with managed print server 120, which registration includes mapping record 160 which includes their OS usernames 164 and computer names 168. As will managed be detailed below, a permissions list is then retrieved. User's 124 and 136 have direct printing permission, resulting in generation of printouts 172 and 176, respectively. User 148 lacks direct print permission and their printout is not rendered as indicated at 180.

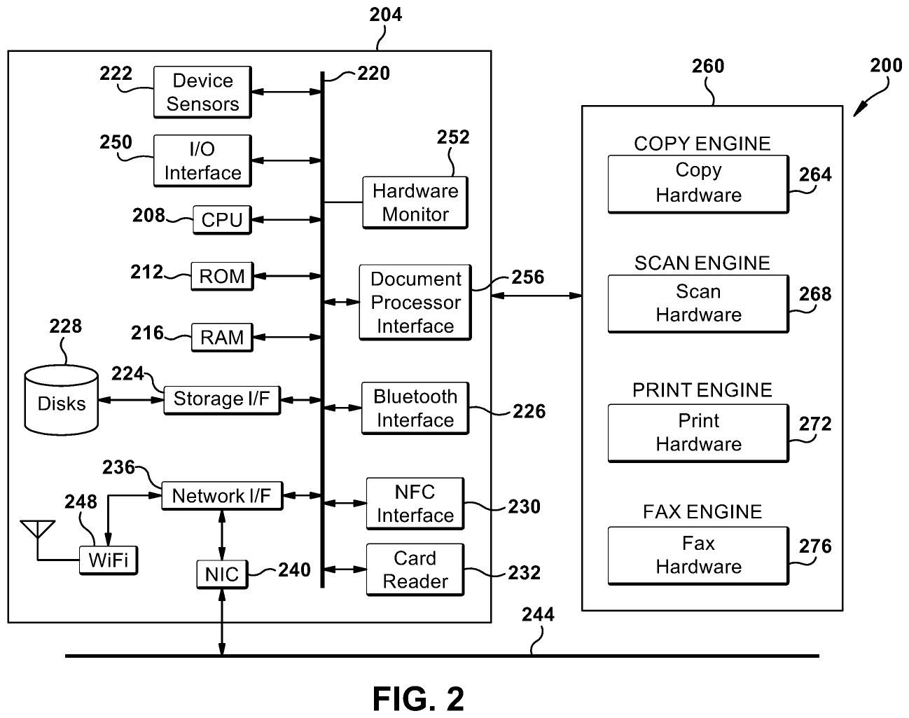

Turning now to FIG. 2, illustrated is an example embodiment of a networked digital device comprised of document rendering system 200 suitably comprised within an MFP, such as with MFPs 104, 108 and 112 of FIG. 1. It will be appreciated that an MFP includes an intelligent controller 204 which is itself a computer system. Thus, an MFP can itself function as a server with the capabilities described herein. Included in intelligent controller 204 are one or more processors, such as that illustrated by processor (CPU) 208. Each processor is suitably associated with non-volatile memory, such as read-only memory (ROM) 212, and random access memory (RAM) 216, via a data bus 220.

Processor 208 is also in data communication with a storage interface 224 for reading or writing to a storage 228, suitably comprised of a hard disk, optical disk, solid-state disk, cloud-based storage, or any other suitable data storage as will be appreciated by one of ordinary skill in the art.

Processor 208 is also in data communication with additional interfaces, such as Bluetooth interface 226, NFC interface 230 and card reader 232 for data exchange with proximity cards, such as card keys.

Processor 208 is also in data communication with a network interface 236 which provides an interface to a network interface controller (NIC) 240, which in turn provides a data path to any suitable wired interface or physical network connection 244, or to a wireless data connection via wireless network interface 248. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 208 can also be in data communication with any suitable user input/output (I/O) interface 250 which provides data communication for interfacing with user peripherals, such as displays, keyboards, mice, track balls, touch screens, or the like. While touchscreens are discussed in example embodiments herein, it is to be appreciated that any suitable user interface, such as keyboards, switches, displays, trackballs or mice may be used. Processor 208 can also be in communication with hardware monitor 252, such as a page counter, temperature sensor, toner or ink level sensor, paper level sensor, or the like.

Also in data communication with data bus 220 is a document processor interface 256 suitable for data communication with the document rendering system 260, including MFP functional units. In the illustrated example, these units include a copy engine comprising copy hardware 264, a scan engine comprise of scan hardware 268, a print engine comprised of print hardware 272 and a fax engine comprised of fax hardware 276 which together comprise document rendering system 260. It will be understood that functional units are suitably comprised of intelligent units, including any suitable hardware or software platform.

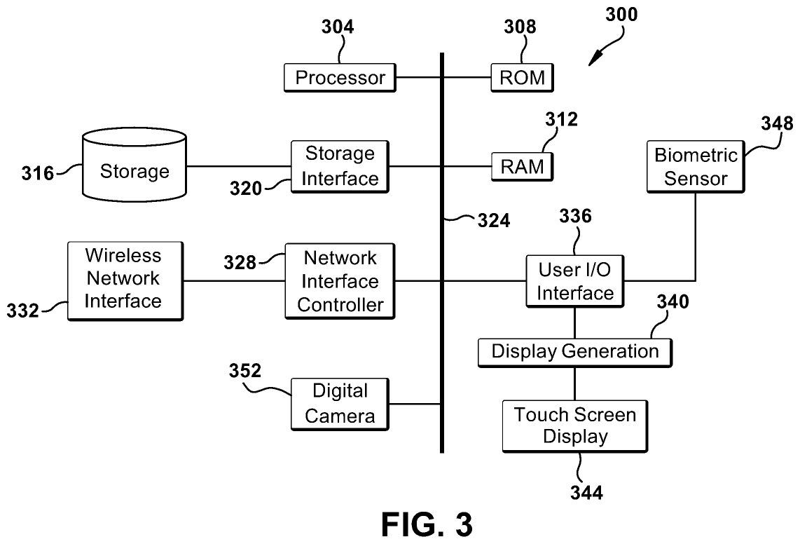

Turning now to FIG. 3, illustrated is an example embodiment of a digital data processing device 300 such as managed print server 120, desktop computer 128, laptop computer 140 and smartphone 152 of FIG. 1. It is to be appreciated that some components listed may be unnecessary in certain configurations. Components of the digital data processing device 300 suitably include one or more processors, illustrated by processor 304, memory, suitably comprised of read-only memory 308 and random access memory 312, and bulk or other non-volatile storage 316, suitably connected via a storage interface 320. Data communication among components is accomplished via data bus 324. A network interface controller 328 suitably provides a gateway for data communication with other devices, via any wireless or wired connection, such as via wireless network interface 332. A user input/output interface 336 is suitably comprised of display generator 340 interfacing with touchscreen display 344. As noted above, any suitable user input and display can be used. User input/output interface 336 also provides connection to biometric sensor 348, suitably comprised of a fingerprint sensor, retinal sensor, or the like, and may be used to secure device access to one or more users. Processor 304 processor is also in data communication with a digital camera 352.

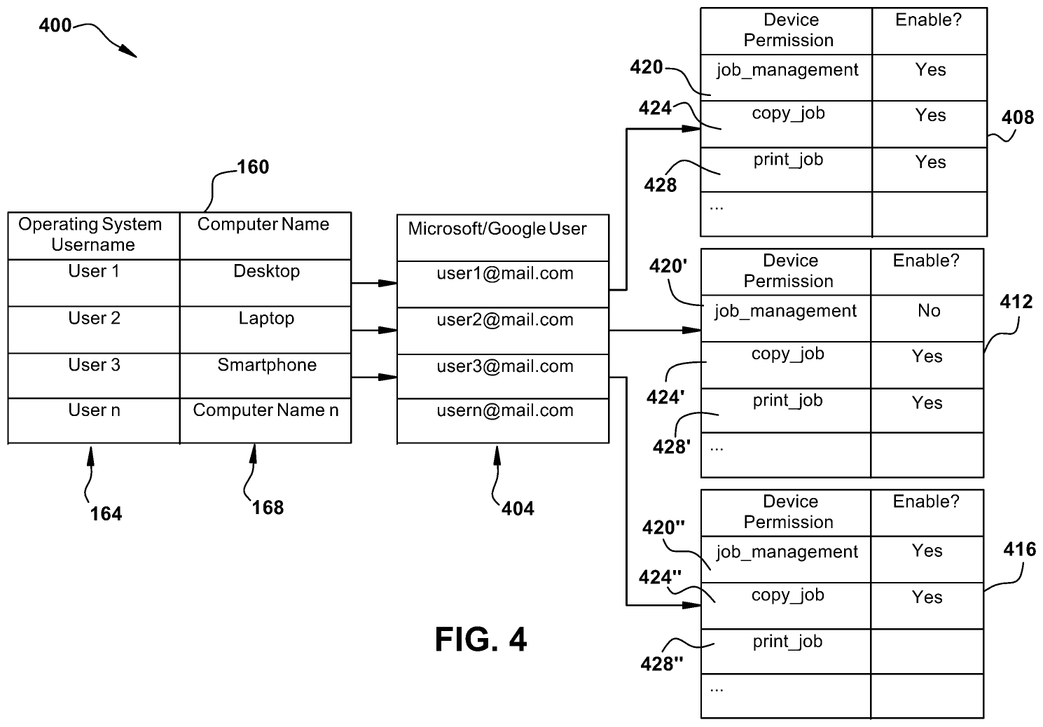

FIG. 4 illustrates a software module diagram, 400 of an example embodiment of a system for authenticating direct network print jobs. Mapping record 160, as illustrated in FIG. 1, shows registration entries for users, including their usernames 164 and computer names 168. User registration records are associated, via email contact information 404, with user's cloud storage accounts, such as a Microsoft OneDrive or Google Drive. Each user is associated with a device permission list. User 1 is associated with device permission list 408, user 2 is associated with device permission list 412 and user 3 is associated with device permission list 416. Each device permission list has an associated set of user device permissions. In the illustrated example, these comprise job management permission 420, 420′ and 420″, copy job permission 424, 424′ and 424″ and print job permission 428, 428′ and 428″ for users 1, 2 and 3, respectively. User 1 has all permissions. User 2 has copy and print, but not job management permissions. User 3 has job management and copy job permissions, but not print job permission. For this reason, user 3 was denied a printout as shown in FIG. 1.

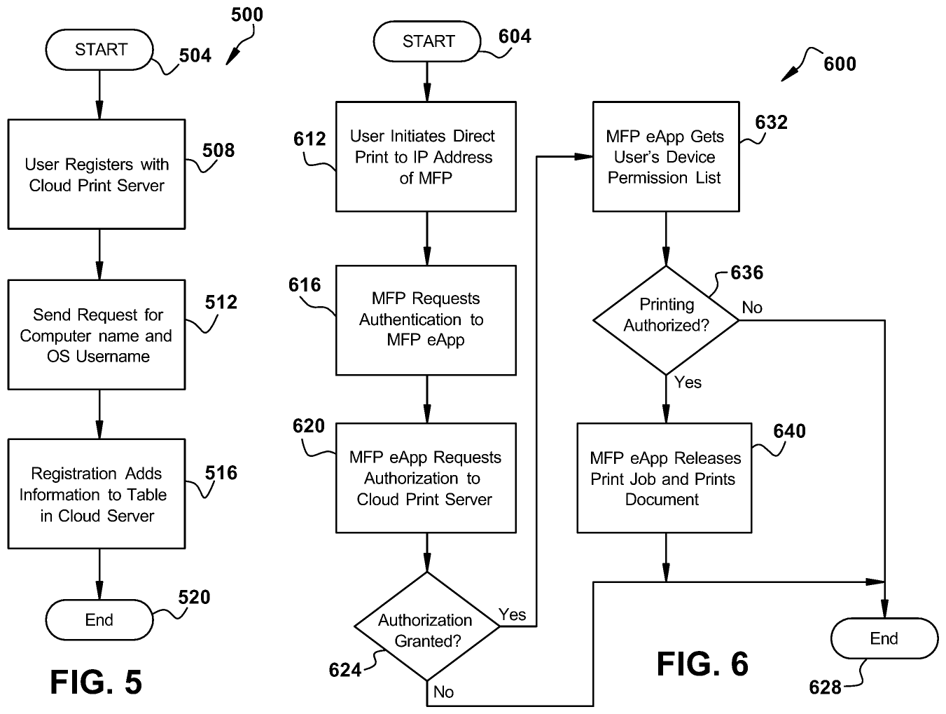

FIG. 5 illustrates a flowchart 500 of an example embodiment of user registration in a system for authenticating direct network print jobs. The process commences at block 504 and proceeds to block 508 where a user registers with a cloud server, such as e-Bridge Global Print. During registration, a request is sent at block 512 for a user's username and computer name. Once received, this information is added to an information table in the cloud server at 516. Registration is then complete and the process ends at block 520.

FIG. 6 illustrates a flowchart 600 of an example embodiment of direct printing in a system for authenticating direct network print jobs. The process commences at block 604 and proceeds to block 612 where a user initiates a direct print to an MFP's address, such as its IP address. The MFP receives the print request and seeks authentication via an eApp at block 616. The eApp then requests authorization from a cloud print server at block 620. A test is made at block 624 to determine if the user is authorized. If not, the process terminates at block 628. If the user is authorized, the MFP eApp gets the user's device permission list from the cloud server at block 632, and a test is made as to whether they have print permission at block 636. If not, the process terminates at block 628. If the user has print permission, the MFP eApp releases the print job and renders it as a printout at block 640.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the spirit and scope of the invention.

1. A system comprising:
a processor;
a memory;
a data interface;
the processor configured to receive, into the memory, registration requests for one or more users via the data interface;
the processor further configured to generate, responsive to each registration request, a registration query for registration data associated with the one or more users via the data interface;
the processor further configured to receive the registration data responsive to the registration query via the data interface;
the processor further configured to register one or more registered users from the one or more users in accordance with the received registration data;
the processor further configured to store, in the memory, a permissions list associatively with the received registration data for the one or more registered users;
the processor further configured to receive one or more print requests from one or more multifunction peripherals, each print request corresponding to a locally stored print job received directly into the one or more multifunction peripherals from the one or more registered users;
the processor further configured send, via the data interface to the one or more multifunction peripherals requesting a print, a print permission for each locally stored print job associated with the one or more registered users; and
the processor further configured to send, via the data interface to the one or more multifunction peripherals receiving the print permission, the permissions list for the print job associated with the one or more registered users.

2. The system of claim 1 wherein the registration data includes data identifying the one or more users and their associated device.

3. The system of claim 2 wherein the memory further stores print jobs received from users via the data interface.

4. The system of claim 3 wherein the processor is further configured to receive a job release request from the one or more multifunction peripherals via the data interface.

5. The system of claim 4 wherein the processor is further configured to send print jobs associated with the job release request from the memory to each associated multifunction peripheral when the print job is associated with the one or more registered users.

6. The system of claim 2 wherein the registration data includes data identifying a user account with one or more public document storage cloud service.

7. The system of claim 6 wherein a public document storage cloud service is comprised of Microsoft OneDrive account or a Google Drive.

8. A method comprising:
receiving, into a memory, registration requests for one or more users via a data interface; generating, responsive to each registration request, a registration query for registration data associated with a user via the data interface;
receiving registration data responsive to the registration query via the data interface;
registering users in accordance with received registration data;
storing, in the memory, a permissions list associatively with the registration data for a registered user;
receiving one or more print requests from one or more multifunction peripherals, each print request corresponding to a locally stored, print job received directly into each multifunction peripheral from the user;
sending, via the data interface to the one or more multifunction peripherals requesting a print, a print permission for the print job associated with the registered user; and
sending, via the data interface to each multifunction receiving the print permission, the permissions list for each locally stored print jobs associated with registered users.

9. The method of claim 8 wherein the registration data includes data identifying the user and their associated device.

10. The method of claim 9 wherein the memory further stores print jobs received from users via the data interface.

11. The method of claim 10 further comprising receiving a job release request from the one or more multifunction peripherals via the data interface.

12. The method of claim 11 further comprising sending print jobs associated with the job release request from the memory to each associated multifunction peripheral when the print job is associated with the registered user.

13. The method of claim 9 wherein the registration data includes data identifying a user account with one or more public document storage cloud service.

14. The method of claim 13 wherein a public document storage cloud service is comprised of Microsoft OneDrive account or a Google Drive.

15. A multifunction peripheral comprising:
a processor;
memory;
a print engine configured to generate a tangible printout of electronic documents;
a data interface associated with a network address;
the processor configured to receive a print job sent to the network address into the memory from a print driver of an associated user device of an identified user;
the processor configured to submit, responsive to a received print job, a print permission request corresponding to the identified user to an associated server via the data interface;
the processor further configured to receive a print permission request response corresponding to the identified user from a server granting or denying the print permission request;
the processor further configured to receive a permissions list for the identified user when print permission is granted; and
the processor further configured to selectively generate a printout of the print job via the print engine in accordance with a received permissions list.

16. The multifunction peripheral of claim 15 wherein a granted permissions list is associated with the identified user being a registered user.

17. The multifunction peripheral of claim 16 wherein the identified user is associated with a username and user device name.

18. The multifunction peripheral of claim 17 wherein the identified user is associated with a public cloud server storage system.

19. The multifunction peripheral of claim 18 wherein the public cloud server storage system is comprised of Microsoft OneDrive or Google Drive.

20. The multifunction peripheral of claim 18 wherein the identified user is associated with the public cloud server storage system in accordance with their email address.
